(19) United States
(12) Patent Application Publication
(10) Pub. No.: US 2011/0039959 A1
(43) Pub. Date: Feb. 17, 2011

(54) POLYOL INCLUDED PHOSPHORUS AND NITROGEN

(76) Inventors: Do-Gyun Kim, Gyeonggi-do (KR); Hyosung Kim, Gyeonggi-do (KR)

Correspondence Address: GREENLEE SULLIVAN P.C., 4875 PEARL EAST CIRCLE, SUITE 200, BOULDER, CO, 80301, US

(21) Appl. No.: 12/666,887

(22) PCT Filed: Jun. 25, 2008
(86) PCT No.: PCT/KR2008/003661

§ 371 Date: Sep. 16, 2010

(30) Foreign Application Priority Data
Jun. 25, 2007 (KR) 10-2007-0062568

(51) Int. Cl. C08J 11/24; C08F 283/06; C08G 18/42

(52) U.S. Cl. 521/48.5; 525/418; 521/157

(57) ABSTRACT

Provided are a phosphorus- and nitrogen-containing polyol composition, a method of preparing the same, and flame-retardant polyol for polyurethane, using the phosphorus- and nitrogen-containing polyol composition. In particular, provided are a phosphorus- and nitrogen-containing polyol which has a structure in which, in the molecule of polyol, phosphorus is co-bound to a hydroxyl group of polyol and an amino group of a nitrogen compound by a chemical reaction, and is prepared to comprise 1-20% of phosphorus and 1-17% of nitrogen, thereby obtaining excellent stability, compatibility with other polyols, reactivity, and flame-retardant characteristics, and a method of preparing the same.

### TECHNICAL FIELD

The present invention relates to a phosphorus- and nitrogen-containing polyol, and more particularly, to a phosphorus- and nitrogen-containing polyol that has a structure in which, in the molecule of polyol, phosphorus is co-bound to a hydroxyl group of polyol and an amino group of a nitrogen compound by a chemical reaction, is prepared to comprise 1-20% of phosphorus and 1-17% of nitrogen, thus having excellent properties, such as solubility with respect to an organic solvent, compatibility with other polyols, stability, reactivity, and flame-retardant properties, and is used as flame-retardant polyol for polyurethane, and a method of preparing the same.

### BACKGROUND ART

Conventional flame-retardant polyols for urethane have been formed by physically mixing a general polyol composition with a flame-retardant additive such as phosphorus-based flame-retardant, organic halogen compounds, organic nitrogen compounds, inorganic metal compounds, and the like and dispersing them in the polyol composition. In particular, for example, Korean Patent Application Nos. 10-1990-0016122, 10-1991-0018915 and 10-2004-0048973 and U.S. Pat. Nos. 4,221,875, 4,258,141 and 4,293,657 disclose a method of obtaining a flame-retardant property by using melamine phosphate or melamine powder as a flame retardant. However, the flame retardant is physically mixed with polyol instead of a chemical bond, and thus satisfactory results in terms of dispersibility and flame-retardant effects cannot be obtained. A conventional flame-retardant polyol has poor dispersibility and compatibility with other polyols, and thus physical and chemical properties are unsatisfactory. In addition, the flame retardant is leaked from a final product, thereby reducing flame-retardant properties. As a result, combustion cannot be efficiently prevented, and toxic combustion gases occur, thereby causing a significant damage to human lives. In addition, when resin wastes are incinerated and processed, toxic chemical materials are generated, which cause serious social problems such as environmental contamination. Thus, the use of flame-retardant polyols is strictly regulated worldwide. Therefore, there is still a need to develop flame-retardant products with better stability.

### DETAILED DESCRIPTION OF THE INVENTION

### Technical Problem

The present inventors intensely researched and studied ways of overcoming various problems associated with the prior art, and as a result, they invented a method of preparing a phosphorus- and nitrogen-containing polyol, the method including (a) a method of preparing a phosphorus- and nitrogen-containing polyol comprising 1-20% of phosphorus and 1-17% of nitrogen by depolymerizing a depolymerizable polymer by using polyhydric alcohol, adding polybasic acid and polyhydric alcohol to the depolymerized polymer and condensation polymerizing the polymer to prepare a polyester polyol composition, a polyester-amide polyol composition, a polyether polyol composition, a polyether-ester polyol composition, and a polyether-ester amide composition, addition-reacting a nitrogen compound with the composition, and then addition-reacting a phosphorus compound to the resulting composition; (b) a method of preparing a phosphorus- and nitrogen-containing polyol comprising 1-20% of phosphorus and 1-17% of nitrogen by condensation polymerizing polybasic acid and polyhydric alcohol to prepare a polyester polyol composition having an acid value of 0.1-5 mg KOH/g, a hydroxyl value of 20-500 mg KOH/g, and an average molecular weight of 500-10,000, addition-reacting a nitrogen compound with the polyester polyol composition, and then addition-reacting a phosphorus compound with the resulting composition; (c) a method of preparing a phosphorus- and nitrogen-containing polyol comprising 1-20% of phosphorus and 1-17% of nitrogen by continuously injecting and reacting propylene oxide (P/O) in the presence of an alkali metal catalyst to prepare polypropylene polyol having a hydroxyl value of 20-700 mg KOH/g and a molecular weight of 100-5000, addition-reacting a nitrogen compound with the polypropylene polyol, and then addition-reacting a phosphorus compound with the resulting composition; (d) a method of preparing a phosphorus- and nitrogen-containing polyol comprising 1-20% of phosphorus and 1-17% of nitrogen by injecting and addition-reacting P/O and E/O with polyhydric alcohol as an initiator to prepare polyether polyol having a hydroxyl value of 20-800 mg KOH/g and a molecular weight of 200-10000, addition-reacting a nitrogen compound with the polyether polyol, and then addition-reacting a phosphorus compound with the resulting composition; and (e) a method of preparing a phosphorus- and nitrogen-containing polyol comprising 1-20% of phosphorus and 1-17% of nitrogen by injecting and addition-reacting P/O and E/O with polyamine as an initiator to prepare polyether polyol having a hydroxyl value of 20-500 mg KOH/g and a molecular weight of 200-10000, addition-reacting a nitrogen compound with the polyether polyol, and then addition-reacting a phosphorus compound with the resulting composition, in order to improve flame-retardant properties, stability, storage, compatibility, dispersibility, and reactivity of polyol.

In particular, the phosphorus- and nitrogen-containing polyol of the present invention has good compatibility with other polyols, good reactivity with isocyanate, good affinity with additives, miscibility with a foaming agent. In addition, the phosphorus- and nitrogen-containing polyol has excellent flame-retardant and heat-resistance characteristics, and thus the flow of sparks caused by an initial flame does not occur and generation of smoke is significantly low. Moreover, the phosphorus- and nitrogen-containing polyol forms char, thereby making a fire wall, and thus is suitable for preparation of flame-retardant polyurethaneforms having permanent flame-retardant characteristics and self-extinguishing characteristics. Furthermore, after the phosphorus- and nitrogen-containing polyol forms a urethane resin, it is not transferred from the resin and does not generate a volatile material. Moreover, the phosphorus- and nitrogen-containing polyol has excellent properties which do not deteriorate chemical and physical performance, such as non-occurrence of hydrolysis and transesterification reaction.

### Technical Solution

According to a first embodiment of the present invention, there is provided a method of preparing a phosphorus- and nitrogen-containing polyol, the method comprising: (a) adding a depolymerizing agent to a depolymerizable polymer to depolymerize the polymer, thereby preparing a depolymerization composition; (b) adding polybasic acid and polyhydric alcohol to the depolymerization composition of operation (a) to condensation-polymerize the depolymerization composition, thereby preparing a polyol composition; (c) addition-reacting a nitrogen compound with the polyol composition of operation (b) to prepare a nitrogen-containing polyol composition; and (d) addition-reacting a phosphorus compound with the nitrogen-containing polyol composition of operation (c) to prepare a phosphorus- and nitrogen-containing polyol composition.

According to a second embodiment of the present invention, there is provided a method of preparing a phosphorus- and nitrogen-containing polyol, the method comprising: (a) adding a depolymerizing agent to a depolymerizable polymer to depolymerize the polymer, thereby preparing a depolymerization composition; (b) addition-reacting a nitrogen compound with the depolymerization composition of operation (a) to prepare a nitrogen-containing polyol composition; and (c) addition-reacting a phosphorus compound with the nitrogen-containing polyol composition of operation (b) to prepare a phosphorus- and nitrogen-containing polyol composition.

According to a third embodiment of the present invention, there is provided a method of preparing a phosphorus- and nitrogen-containing polyol, the method comprising: (a) condensation-polymerizing polybasic acid and polyhydric alcohol to prepare a polyesterpolyol composition; (b) addition-reacting a nitrogen compound with the polyesterpolyol composition of operation (a) to prepare a nitrogen-containing polyesterpolyol composition; and (c) addition-reacting a phosphorus compound with the nitrogen-containing polyesterpolyol composition of operation (b) to prepare a phosphorus- and nitrogen-containing polyol composition.

According to a fourth embodiment of the present invention, there is provided a method of preparing a phosphorus- and nitrogen-containing polyol, the method comprising: (a) reacting propylene oxide (P/O) in the presence of an alkali metal catalyst to prepare a polypropylenepolyol composition; (b) addition-reacting a nitrogen compound with the polypropylenepolyol composition of operation (a) to prepare a nitrogen-containing polyetherpolyol composition; and (c) addition-reacting a phosphorus compound with the nitrogen-containing polyetherpolyol composition of operation (b) to prepare a phosphorus- and nitrogen-containing polyetherpolyol composition.

According to a fifth embodiment of the present invention, there is provided a method of preparing a phosphorus- and nitrogen-containing polyol, the method comprising: (a) addition reacting propylene oxide (P/O) and ethylene oxide (E/O) with polyhydric alcohol to prepare a polyhydric alcohol+P/O+E/O-added polyol composition; (b) addition reacting a nitrogen compound with the polyhydric alcohol+P/O+E/O-added polyol composition of operation (a) to prepare a nitrogen-containing polyetherpolyol composition; and (c) addition reacting a phosphorus compound with the nitrogen-containing polyetherpolyol composition of operation (b) to prepare a phosphorus- and nitrogen-containing polyetherpolyol composition.

According to a sixth embodiment of the present invention, there is provided a method of preparing a phosphorus- and nitrogen-containing polyol, the method comprising: (a) addition reacting propylene oxide (P/O) and ethylene oxide (E/O) with a mixture of polyhydric alcohol and polyamine to prepare a polyhydric alcohol+polyamine+P/O+E/O-added polyol composition; (b) addition reacting a nitrogen compound with the polyhydric alcohol+polyamine+P/O+E/O-added polyol composition of operation (a) to prepare a nitrogen-containing polyol composition; and (c) addition reacting a phosphorus compound with the nitrogen-containing polyol composition of operation (b) to prepare a phosphorus- and nitrogen-containing polyol composition.

### Advantageous Effects

As described above, the phosphorus- and nitrogen-containing polyol of the present invention has a structure in which, in the molecule of polyol, phosphorus is co-bound to a hydroxyl group of polyol and an amino group of a nitrogen compound by a chemical reaction. Thus, the phosphorus- and nitrogen-containing polyol has excellent stability, compatibility, and flame-retardant characteristics and reactivity thereof with isocyante is excellent. Therefore, the prepared flame-retardant polyurethane and flame-retardant polyurethaneforms form char on a surface thereof during combustion, thereby making a fire wall. Accordingly, transfer of flames is prevented and the flow of sparks caused by an initial flame does not occur. In addition, the phosphorus- and nitrogen-containing polyol has self-extinguishing characteristics and permanent flame-retardant characteristics, and thus can be used as an environmentally-friendly and economically and industrially useful substance.

### Best Mode

In the first and second embodiments of the present invention, the depolymerizable polymer may be polyester such as PET polymer and waste PET fiber synthesized from terephthalic acid and ethylene glycol, waste PET bottles, waste PET molded products, waste polyester fiber, and water polyester molded products, a waste mixture of polyester and polyamide, such as beer PET bottle waste, blend fiber of polyester and polyamide, and combined molded products of polyester and polyamide, or polyurethane such as waste urethane form, waste urethane fiber, waste urethane artificial leather, and urethane elastomer. These polymers are obtained by mechanical pulverization, washing, and drying.

The depolymerizing agent may be at least one selected from the group consisting of ethylene glycol, propylene glycol, diethylene glycol, 1,4-butanediol, 1,6-hexanediol, neopentyl glycol, dipropylene glycol, trimethylol propane, glycerin, pentaerythritol, fatty acid monoglyceride, 1,3-propanediol, polyethylene glycol, polypropylene glycol, polytetramethylene ether glycol (PTMEG), an alkyleneoxide adduct of bisphenol A, and polymeric fatty acid monopolyhydroxy alcoholide.

The amount of the depolymerizing agent may be in a range of 3-150 wt % based on the weight of the depolymerizable polymer.

Examples of the polybasic acid may include phthalic anhydride, isophthalic acid and ester thereof, terephthalic acid and ester thereof, 5-dimethylsodiumsulfoisophthalate (DMSSIP), adipic acid and ester thereof, azelaic acid, sebacic acid, anhydrous tetra hydrophthalic acid, anhydrous maleic acid, fumaric acid, itaconic acid, trimellitic acid, anhydrous trimellitic acid, anhydrous pyromellitic acid, succinic acid, cyclohexanedi-carboxylic acid, naphthalene dicarboxylic acid, benzoic acid, dimer acid, C₉—C₂₇ fatty acid, and the like. They can be used alone or in mixtures thereof. The amount of the polybasic acid is preferably 1-50 wt % based on the weight of the depolymerization composition.

Examples of the polyhydric alcohol may include ethylene glycol, proplyene glycol, 1,3-propane diol, 1,4-butane diol, 1,6-hexane diol, neopentyl glycol, diethylene glycol, dipropylene glycol, polyethylene glycol, polypropylene glycol, PTMEG, alkylene oxide adduct of bisphenol A, trimethylol propane, glycerin, pentaerythritol, sucrose, sorbitol, fatty acid monoglyceride, polymeric fatty acid monopolyhydroxy alcoholide, and the like. They can be used alone or in mixtures thereof. The amount of the polyhydric alcohol added may be in a range of 1-70 wt % with respect to the weight of the depolymerization composition.

The catalyst for depolymerization may be organic acid metals, tin hydroxide, and alkali metal hydroxide. The amount of the catalyst used may be in a range of 0.05-5 wt % with respect to the weight of the reactant.

The polyetherpolyol according to the sixth embodiment of the present invention may be prepared using polyhydric alcohol and alkylene oxide adduct that are produced by additionally reacting alkylene oxide with polyhydric alcohol and polyamine used as an initiator in the presence of an alkali metal catalyst.

In addition, the polyhydric alcohol used in the preparing of the polyol of operation (a) of each of the fifth and sixth embodiments of the present invention may be, in general, ethylene glycol having 2 to 8 hydroxy functional groups, propylene glycol, 1,3-propanediol, 1,4-butanediol, 1,6-hexanediol, neopentyl glycol, diethylene glycol, dipropylene glycol, polyethylene glycol, polypropylene glycol, PTMEG, an alkyleneoxide adduct of bisphenol A, trimethylol propane, glycerin, pentaerythritol, sucrose, sorbitol, fatty acid monoglyceride,and polymeric fatty acid monopolyhydroxy alcoholide. The polyhydric alcohol may be used alone or in mixtures of the above materials. In this regard, the amount of polyhydric alcohol may be in a range of 1-70 wt % with respect to the total weight of the prepared polyol.

The polyamine used in the preparing of the polyol composition of operation (a) according to the sixth embodiment of the present invention may be triethyl amine, propyl amine, butyl amine, ethylene diamine, diethylene triamine, triethylene tetramine, monoethanol amine, diethanol amine, triethanol amine, dimethylethanol amine, 1-amino-2-propanol, morpholine, a morpholine derivative, O-toluenediamine, isophoronediamine, diethyleneglycolamine, hexamethylenediamine, piperidine, or the like. The polyamine may be used alone or in mixtures of the above materials. In this regard, the amount of polyamine may be in a range of 5-120 parts by weight based on 100 parts by weight of the polyhydric alcohol.

In the preparing of the polyol composition of operation (a) of each of the fifth and sixth embodiments of the present invention, alkylene oxide such as ethylene oxide (E/O) or propylene oxide (P/O) may be used, and butylene oxide (B/O) may also be used. In this regard, the amount of alkylene oxide may be in a range of 5-120 parts by weight based on 100 parts by weight of the polyhydric alcohol.

When E/O or P/O is used, a weight ratio of E/O to P/O may be in a range of 8:2 to 2:8.

The preparing of the polyetherpolyol according to the fourth embodiment of the present invention may be, in particular, performed by adding polyhydric alcohol to an autoclave and reacting the polyhydric alcohol with P/O at 110-120° C. for 5 to 10 hours is while P/O is added using a metering pump at a rate of 100g/min to prepare polyetherpolyol having a hydroxyl value of 20-800 mg KOH/g, viscosity of 200-50,000 CPS/25° C., and average functional value of 3 to 8.

In the first, second, third, fourth, fifth, and sixth embodiments of the present invention, the nitrogen compound may be melamine, a melamine derivative, urea, a urea derivative, guanidine, a guanidine derivative, dicyandiamide, a dicyandiamide derivative, cyanuric acid, a cyanuric acid derivative, polyamine, or the like. They can be used alone or in mixtures of the above materials. The amount of nitrogen compound added may be in a range of 1-70 wt % with respect to the composition of operation (c) of the first embodiment and the compositions of operation (b) of the second through sixth embodiments.

The phosphorus compound used in operation (d) of the first embodiment and operation (c) of each of the second through sixth embodiments may be ortho-phosphoric acid, pyrophosphoric acid, polyphosphoric acid, phosphorus pentoxide, monophosphoric acid ester, phosphorus oxychloride, phosphorus trichloride, phosphorus pentachloride, alkylphosphite, arylphosphite, dialkylphosphonate, trialkylphosphite, dialkylhydrogenphosphite, or the like. These compounds may be used alone or in mixtures of the above materials. 1-50 wt % of the phosphorus compound may be added to the product of each operation.

The phosphorus- and nitrogen-containing polyols of the first through sixth embodiments of the present invention may contain 1-20% of phosphorus atoms and 1-17% of nitrogen atoms of the total weight of the polyol in a molecular structure.

Hereinafter, as an embodiment of applying the phosphorus- and nitrogen-containing polyol of the present invention, a method of preparing a flame-retardant polyurethaneform, a flame-retardant polyurethane coating agent, and a flame-retardant urethane molded product by using the phosphorus- and nitrogen-containing polyol according to one of the first through sixth embodiments of the present invention will be described.

In using the flame-retardant polyols obtained according to the first through sixth embodiments, it is preferable to obtain a polyol mixture having a hydroxyl value of 20-800 mg KOH/g by being mixed with another polyol according to requirements such as hardness, mechanical properties, and the like, of flame-retardant polyurethane form.

Examples of the other polyol include ethylene glycol, diethyl glycol, propylene glycol, trimethylolpropane, glycerin, sorbitol, bisphenol A ethylene oxide, propylene oxide-added polyol, glycerin ethylene oxide propylene oxide-added polyether polyol, pentaerythritol ethylene oxide propylene oxide-added polyether polyol, sucrose ethylene oxide propylene oxide-added polyether polyol, sorbitol ethylene oxide propylene oxide-added polyether polyol, polyamine ethylene oxide propylene oxide-added polyether polyol, polyesteramide polyol, polyether-ester-amide polyol, polyether polyol, polyester polyol, 1,4-butanediol, and the like.

The polyol mixture may be at least one polyol mixture selected from the group consisting of (a) a polyol mixture comprising 5-70 wt % of phosphorus- and nitrogen-containing polyester polyol, 5-60 wt % of glycerin+E/O+P/O-added polyether polyol, 5-50 wt % of pentaerythritol+E/O+P/O-added polyether polyol, and 5-50 wt % of sucrose+E/O+P/O-added polyether polyol; (b) a polyol mixture comprising 5-70 wt % of phosphorus- and nitrogen-containing polyester-amidepolyol, 5-60 wt % of glycerin+E/O+P/O-added polyether polyol, 5-50 wt % of pentaerythritol+E/O+P/O-added polyether polyol, and 5-50 wt % of sucrose+E/O+P/O-added polyether polyol; (c) a polyol mixture comprising 5-70 wt % of phosphorus- and nitrogen-containing polyester polyol, 5-70 wt % of polyester-amidepolyol, 5-60 wt % of glycerin+E/O+P/O-added polyether polyol, 5-50 wt % of pentaerythritol+E/O+P/O-added polyether polyol, and 5-50 wt % of sucrose+E/O+P/O-added polyether polyol; (d) a polyol mixture comprising 5-70 wt % of phosphorus- and nitrogen-containing sucrose+E/O+P/O-added polyether polyol, 5-60 wt % of polyester-amidepolyol, 5-60 wt % of glycerin+E/O+P/O adduct, 5-50 wt % of pentaerythritol+E/O+P/O-added polyether polyol, and 5-50 wt % of sucrose+E/O+P/O-added polyether polyol; (e) a polyol mixture comprising 5-70 wt % of phosphorus- and nitrogen-containing polyether polyol, 5-70 wt % of polyether-ester-amidepolyol, 5-50 wt % of 1,4-butanediol, 5-30 wt % of polyether polyol, and 5-70 wt % of PTMEG; and (f) a polyol mixture comprising 5-70 wt % of phosphorus-and nitrogen-containing polyester-amidepolyol, 5-70 wt % of polyetherpolyol, and 5-50 wt % of polyester polyol. However, the present invention is not limited thereto.

In this regard, the polyol mixtures (a), (b), (c) and (d) are used in preparing a flame-retardant rigid polyurethane form, the polyol mixture (e) is used in preparing a flame-retardant elastic polyurethane form, and the polyol mixture (f) is used in preparing a flame-retardant flexible polyurethane form.

The polyol mixture comprising flame-retardant polyol has an average hydroxyl value of 20-800 mg KOH/g, and isocyanate has NCO % of 28-33. A ratio (NCO/OH) of NCO group of isocyanate to hydroxyl group of the polyol is in a range of 0.5 to 1.5.

Examples of the isocyanate include toluene diisocyanate, xylene diisocyanate, crude-MDI, MDI, polymeric MDI, hexamethylene diisocyanate, isophorone diisocyanate, isocyanate trimer, and the like.

The catalyst may be amines, for example, triethyl amines, ethanol amines, dimethyl ethanol amines, diethylene triamines, triethylene diamines, hexadecyl dimethyl amine, N-methyl morpholine, tetramethyl ethylene diamine, dimethyl cyclohexyl amine, pentamethyl diethylene triamine, dialkyl piperadines, or the like. The amount of catalyst used may be in a range of 1-10 wt % with respect to the weight of a reactant.

CFCs or HCFCs are used as conventional foaming agents, but use thereof has been banned since it was proven that CFCs and HCFCs deplete the ozone layer of the atmosphere. Thus, as an alternative, pentane, cyclopentane, and water may be used together as a foaming agent. A surfactant may be silicone surfactant.

The flame-retardant polyurethaneforms of the present invention are formed basically in the chemical structure of phosphorus-containing mixed polyol and isocyanate. By including a foaming agent in the phosphorus-containing mixed polyol and including a surfactant, an additive, and the like in a reaction catalyst, the resultant is reacted with isocyanate to obtain the flame-retardant polyurethane form in which independent foams of the foaming agent are dispersed in polyurethane and which has flame-retardant characteristics, heat-resistance, insulation properties, and intensity. These physical properties are determined by the physical structure of polyurethane form, such as cell diameter, cell dimension, cell distribution, and the like, and thus they are significantly influenced by the compatibility and reactivity of each material and fluidity at the time of ejection. In particular, selection of the polyol and its configuration are important.

The phosphorus- and nitrogen-containing polyol according to the present invention has the partial solubility of the foaming agent, pentane and cyclopentane, and it increases the CO₂ ejection pressure in and out of the cell of polyurethane form when used together with water. Thus, it is easy to control the physical structure of the polyurethane forms, such as cell diameter, cell dimension, cell distribution, and the like, and the polyurethaneforms with improved flame-retardant characteristics, heat-resistance and insulation properties and increased mechanical intensity can be prepared.

The flame-retardant polyurethane coating agent of the present invention is basically formed in the chemical structure of phosphorus- and nitrogen-containing mixed polyol and isocyanate. The isocyanate is added to the polyol composition prepared by mixing the phosphorus- and nitrogen-containing polyol component with a curing accelerator, a colorant, a flame-retardant, an additive, a solvent, and the like to coat on textiles, non-woven fabric, wooden material, or the like to prepare artificial leather or to use as coating on lumber surfaces.

The flame-retardant polyurethane molded product of the present invention is basically formed in the chemical structure of phosphorus- and nitrogen-containing mixed polyol and isocyanate. The isocyanate is added to the polyol composition prepared by mixing the phosphorus- and nitrogen-containing polyol component with a curing accelerator, an additive, a flame-retardant, a filler, and the like, and the resultant is cured to use for synthetic wood, artificial wood, sculpture substance, and the like.

All types of the flame-retardant polyurethane products have excellent flame-retardant characteristics and heat-resistance, and thus the flow of sparks caused by an initial flame does not occur, and the flame-retardant polyurethane products form char to make a fire wall, whereby they are best suitable for preparation of flame-retardant polyurethaneforms having permanent flame-retardant and self-extinguishing characteristics. In addition, after the flame-retardant polyurethane products form a urethane resin, they are not transferred from the resin and do not generate a volatile material. Moreover, the flame-retardant polyurethane products have excellent properties which do not deteriorate chemical and physical performance, such as non-occurrence of hydrolysis and transesterification reaction.

Hereinafter, a method of preparing the phosphorus- and nitrogen-containing polyols according to the first through sixth embodiments of the present invention and a method of preparing flame-retardant polyurethaneforms (for example, flame-retardant flexible polyurethaneforms, flame-retardant rigid polyurethaneforms, flame-retardant elastic polyurethaneforms , and the like), a flame-retardant polyurethane coating agent, a flame-retardant polyurethane molded product, and flame-retardant artificial wood by using the preparation method of the phosphorus- and nitrogen-containing polyols will be described in greater detail with reference to the following examples. These examples are provided only for illustrative purpose and are not intended to limit the scope of the present invention.

### Synthesis Example 1

300 g of a waste PET chip, 300 g of diethylene glycol, and 0.3 g of DBTO were added to a reactor equipped with an agitator, a reflux condenser, a thermometer, and a nitrogen inlet and the mixture was heated to be depolymerized at 250° C. for 3 hours. Then the depolymerized mixture was cooled down, 10 g of adipic acid and 150 g of diethylene glycol were added to the mixture, and the temperature of the reactor was raised to 230° C. to condensation polymerize the mixture for 5 hours. Then the resultant was cooled down, 150 g of a melamine derivative and 90 g of diethane amine were added to the resultant, and the mixture was reacted at 150° C. or less for 3 hours. Then the resultant was cooled down, 220 g of phosphorus trichloride was added to the resultant, and the mixture was reacted at 25° C. for 2 hours. As a result, phosphorus- and nitrogen-containing polyol having an acid value of 0.3 mg KOH/g and a hydroxyl value of 305 mg KOH/g and comprising 11% of nitrogen and 17% of phosphorus was prepared.

### Synthesis Example 2

300 g of a waste mixture comprising polyester (PET) and polyamide (nylon), 300 g of diethylene glycol, and 0.3 g of DBTO were added to an autoclave equipped with an agitator, a reflux condenser, a thermometer, and a nitrogen inlet and the mixture was heated to be depolymerized at 250° C. for 3 hours. Then, the depolymerized mixture was cooled down, 5 g of adipic acid and 100 g of 1,4-butanediol were added to the mixture at 170° C., and the temperature of the autoclave was raised to 230° C. to condensation polymerize the mixture for 5 hours. Then the resultant was cooled down, 190 g of polyphosphoric acid was added to the resultant, and the mixture was reacted at 65° C. for 2.5 hours. As a result, phosphorus- and nitrogen-containing polyol having an acid value of 0.5 mg KOH/g and a hydroxyl value of 300 mg KOH/g and comprising 9% of nitrogen and 18% of phosphorus was prepared.

### Synthesis Example 3

300 g of polyester-amide resin (lump polyester-amide resin disclosed in Korean Patent Application No. 10-2004-0020944) that was recycled from a waste mixture of polyester (PET) and polyamide (nylon), 300 g of polymeric fatty acid monopolyhydroxy alcoholide (disclosed in <Synthesis Example 5> of Korean Patent Application No. 10-2004-0081160), and 0.2 g of DBTO were added to a reactor equipped with an agitator, a reflux condenser, a thermometer, and a nitrogen inlet and the mixture was heated to be depolymerized at 250° C. for 3 hours. Then the depolymerized mixture was cooled down, 5 g of adipic acid and 100 g of trimethylol propane were added to the mixture at 170° C., and the temperature of the reactor was raised to 230° C. to condensation polymerize the mixture for 5 hours. Then the resultant was cooled down, 170 g of a melamine derivative was added to the resultant, and the mixture was reacted at 180° C. for 3 hours. Then the resultant was cooled down, 190 g of ortho-phosphoric acid was added to the resultant, and the mixture was reacted at 75° C. for 3.5 hours. As a result, phosphorus- and nitrogen-containing polyol having an acid value of 0.6 mg KOH/g and a hydroxyl value of 470 mg KOH/g and comprising 12% of nitrogen and 18% of phosphorus was prepared.

### Synthesis Example 4

350 g of waste polyurethaneform, 300 g of polymeric fatty acid monopolyhydroxy alcoholide prepared in <Synthesis Example 6> of Korean Patent Application No. 10-2004-0081160, and 0.3 g of DBTO were added to an autoclave and the mixture was reacted at 250° C. for 3 hours. Then the reaction mixture was cooled down, 250 g of urea was added to the mixture at 150° C., and the mixture was heated up to 125° C. and reacted. Then the resultant was cooled down, 100 g of ortho-phosphoric acid and 100 g of phosphorus pentoxide were added to the resultant, and the mixture was reacted at 60° C. for 2 hours. As a result, phosphorus- and nitrogen-containing polyol having an acid value of 0.6 mg KOH/g and a hydroxyl value of 470 mg KOH/g and comprising 9% of nitrogen and 18% of phosphorus was prepared.

### Synthesis Example 5

200 g of diethylene glycol, 70 g of terephthalic acid, 70 g of isophthalic acid, 150 g of ethylene glycol, 50 g of 1,4-butanediol, and 0.2 g of DBTO were added to a reactor equipped with an agitator, a reflux condenser, a thermometer, and a nitrogen inlet and the mixture was condensation polymerized at 230° C. for 7 hours. Then the mixture was cooled down, 100 g of urea and 70 g of triethanol amine were added to the mixture at 150° C. or less, and the mixture was reacted at 150° C. for 3 hours. Then the resultant was cooled down, 90 g of ortho-phosphoric acid was added to the resultant, and the mixture was reacted at 60° C. for 2 hours. As a result, phosphorus- and nitrogen-containing polyol having an acid value of 3 mg KOH/g and a hydroxyl value of 370 mg KOH/g and comprising 7% of phosphorus and 13% of nitrogen was prepared.

### Synthesis Example 6

350 g of sugar, 150 g of glycerin, and 2.5 g of methyl imidazole were added to an autoclave, the inside temperature of the autoclave was raised to 105° C. in a dry nitrogen atmosphere, and 1250 g of propylene oxide (P/O) was added to the mixture at a rate of 50 g/min at an internal pressure of 3.5 kgcm² G. Then the mixture was reacted at 103° C. for 9 hours, 200 g of hydroxyoxapentylmelamine was added to the mixture, and the mixture was reacted at 180° C. for 3 hours. Than, the resultant was cooled down, 200 g of phosphorus oxychloride was added to the resultant, and the mixture was reacted at 25° C. for 2 hours. As a result, phosphorus- and nitrogen-containing polyol having an acid value of 0.1 mg KOH/g and a hydroxyl value of 470 mg KOH/g and comprising 9% of nitrogen and 15% of phosphorus was prepared.

### Synthesis Example 7

150 g of sugar, 250 g of triethanol amine, and 2.5 g of methyl imidazole were added to an autoclave, the inside temperature of the autoclave was raised to 105° C. in a dry nitrogen atmosphere, and 1150 g of P/O was added to the mixture at a rate of 50 g/min at an internal pressure of 3.5 kgcm² G. Then the mixture was reacted at 115° C. for 8 hours, 200 g of urea was added to the mixture, and the mixture was reacted at 125° C. for 3 hours. Then the resultant was cooled down, 200 g of phosphoric anhydride was added to the resultant, and the mixture was reacted at 65° C. for 2 hours. As a result, phosphorus- and nitrogen-containing polyol having an acid value of 0.2 mg KOH/g and a hydroxyl value of 490 mg KOH/g and comprising 12% of nitrogen and 17% of phosphorus was prepared.

A method of preparing flame-retardant polyurethane and flame-retardant polyurethaneforms by applying the phosphorus- and nitrogen-containing polyols prepared in Synthesis Examples 1 through 6 above will now be described in greater detail with reference to the following examples.

### Example 1

300 g of the product prepared in <Synthesis Example 1>, 150 g of polyester polyol, 150 g of polyether polyol PP-2000 (Korea Polyol), 100 g of ethyl acetate, and 0.5 g of DBTDL were mixed in a mixer equipped with an agitator. Then, 200 g of toluene diisocyanate trimer was slowly added to the mixture and mixed together to prepare a flame-retardant urethane coating agent for lumber to coat on a floor. As a result of observation of a surface of the floor after 5 hours, the surface was completely hardened to have excellent elasticity, hardness and gloss, and, in particular, a firm coating film with excellent water resistance was formed. A sample of the product was prepared, and after 48 hours, a flammability test was performed on the sample by applying flames by using a gas Bunsen burner. As a result, the product exhibited flame-retardant characteristics of UL-94V-0 level having self-extinguishing characteristics in which only a portion directly contacted by flames is carbonized and is extinguished when the flames are removed.

### Example 2

200 g of the product prepared in <Synthesis Example 2>, 200 g of polyether polyol GP3000 (Korea Polyol), 110 g of aluminum hydroxide, 0.5 g of a curing accelerator, and 8 g of a surfactant F-317 (Sinetsu Chemical) were mixed in a mixer equipped with an agitator. Then, 250 g of Cosmonate M-200 (Keumho Mitsui Chemical) was added to the mixture and mixed using a high speed agitator, and the resultant was injected into a mold frame to prepare a synthetic wood. A sample of the product was prepared, and after 48 hours, a flammability test was performed on the sample by applying flames by using a gas Bunsen burner. As a result, the product exhibited flame-retardant characteristics of UL-94V-0 level having self-extinguishing characteristics in which only a portion directly contacted by flames is carbonized and is extinguished when the flames are removed.

### Example 3

200 g of the product prepared in <Synthesis Example 3>, 50 g of 1,4-butanediol, 150 g of PTMEG, 0.5 g of a curing accelerator, 8 g of a surfactant B8404 (Goldschmidt), 50 g of a foaming agent, cyclopentane, and 9 g of water were mixed in a mixer equipped with an agitator. Then, 300 g of toluene diisocyanate trimer was slowly added to the mixture and mixed using a high speed agitator to prepare flame-retardant elastic urethaneforms. A sample of the product was prepared, and after 48 hours, a flammability test was performed on the sample by applying flames by using a gas Bunsen burner. As a result, the product exhibited flame-retardant characteristics of UL-94V-0 level having self-extinguishing characteristics in which only a portion directly contacted by flames is carbonized and is extinguished when the flames are removed.

### Example 4

150 g of the product prepared in <Synthesis Example 4>, 150 g of polyether polyol Nixol CF-145 (Korea Polyol), 6 g of a surfactant B8404 (Goldschmidt), 3 g of a catalyst, Kaoriser (Kao Co., Ltd.), 30 g of a foaming agent, cyclopentane, and 7 g of water were mixed in a mixer equipped with an agitator. Then, 200 g of toluene diisocyanate was added to the mixture and mixed using a high speed agitator to prepare flame-retardant flexible urethaneforms. A sample of the product was prepared, and after 48 hours, a flammability test was performed on the sample by applying flames by using a gas Bunsen burner. As a result, the product exhibited flame-retardant characteristics of UL-94V-0 level having self-extinguishing characteristics in which only a portion directly contacted by flames is carbonized and is extinguished when the flames are removed.

### Example 5

200 g of the product prepared in <Synthesis Example 5>, 50 g of glycerin+E/O+P/O-added polyether polyol, 100 g of sucrose-F E/O+P/O-added polyether polyol, 50 g of sorbitol+E/O+P/O-added polyether polyol, 8 g of a surfactant B8404 (Goldschmidt), 3.5 g of a catalyst Dabco 15 (Airo Products), 32 g of a foaming agent, cyclopentane, and 9 g of water were mixed in a mixer equipped with an agitator. Then, 400 g of Cosmonate M-200 was added to the mixture and mixed using a high speed agitator to prepare flame-retardant rigid urethaneforms. A sample of the product was prepared, and after 48 hours, a flammability test was performed on the sample by applying flames by using a gas Bunsen burner. As a result, the product exhibited flame-retardant characteristics of UL-94V-0 level having self-extinguishing characteristics in which only a portion directly contacted by flames is carbonized and is extinguished when the flames are removed.

### Example 6

200 g of the product prepared in <Synthesis Example 6>, 50 g of glycerin+E/O+P/O-added polyether polyol, 50 g of sucrose-F E/O+P/O-added polyether polyol, 50 g of sorbitol+E/O+P/O-added polyether polyol, 50 g of bisphenol+E/O-added polyether polyol, 8 g of a surfactant B8404 (Goldschmidt), 3.5 g of a catalyst Dabco 15 (Airo Products), 150 g of melamine phosphate, 50 g of a foaming agent, cyclopentane, and 9 g of water were mixed in a mixer equipped with an agitator. Then, 350 g of Cosmonate M-200 was added to the mixture and mixed using a high speed agitator to prepare flame-retardant rigid urethaneforms. A sample of the product was prepared, and after 48 hours, a flammability test was performed on the sample by applying flames by using a gas Bunsen burner. As a result, the product exhibited flame-retardant is characteristics of UL-94V-0 level having self-extinguishing characteristics in which only a portion directly contacted by flames is carbonized and is extinguished when the flames are removed.

1. A method of preparing a phosphorus- and nitrogen-containing polyol, the method comprising:
(a) adding a depolymerizing agent to a depolymerizable polymer to depolymerize the polymer, thereby preparing a depolymerization composition;
(b) adding polybasic acid and polyhydric alcohol to the depolymerization composition to condensation-polymerize the depolymerization composition, thereby preparing a polyol composition;
(c) addition-reacting a nitrogen compound with the polyol composition of operation (b) to prepare a nitrogen-containing polyol composition; and
(d) addition-reacting a phosphorus compound with the nitrogen-containing polyol composition of operation (c) to prepare a phosphorus- and nitrogen-containing polyol composition.

2. A method of preparing a phosphorus- and nitrogen-containing polyol, the method comprising:
(a) adding a depolymerizing agent to a depolymerizable polymer to depolymerize the polymer, thereby preparing a depolymerization composition;
(b) addition-reacting a nitrogen compound with the depolymerization composition of operation (a) to prepare a nitrogen-containing polyol composition; and
(c) addition-reacting a phosphorus compound with the nitrogen-containing polyol composition of operation (b) to prepare a phosphorus- and nitrogen-containing polyol composition.

3. The method of claim 1, wherein the depolymerization process of operation (a) is performed by transesterification reacting the depolymerizable polymer with polyhydric alcohol as the depolymerizing agent in the presence of a depolymerization catalyst.

4. The method of claim 1, wherein the depolymerizable polymer of operation (a) comprises at least one selected from the group consisting of waste polyester comprising polyethylene terephthalate, a waste mixture of polyester and polyamide, polyurethane, and artificial leather waste in which a mixed fabric of polyester and polyamide is coated with polyurethane.

5. The method of claim 1, wherein the depolymerizing agent of operation (a) comprises at least one selected from the group consisting of ethylene glycol, propylene glycol, diethylene glycol, 1,4-butanediol, 1,6-hexanediol, neopentyl glycol, dipropylene glycol, trimethylol propane, glycerin, pentaerythritol, fatty acid monoglyceride, 1,3-propanediol, polyethylene glycol, polypropylene glycol, polytetramethylene ether glycol (PTMEG), an alkyleneoxide adduct of bisphenol A, and polymeric fatty acid monopolyhydroxy alcoholide.

6. The method of claim 1, wherein the amount of the depolymerizing agent of operation (a) used is in a range of 3-150 wt % with respect to the weight of the depolymerizable polymer.

7. A method of preparing a phosphorus- and nitrogen-containing polyol, the method comprising:
(a) condensation-polymerizing polybasic acid and polyhydric alcohol to prepare a polyesterpolyol composition;
(b) addition-reacting a nitrogen compound with the polyesterpolyol composition of operation (a) to prepare a nitrogen-containing polyesterpolyol composition; and
(c) addition-reacting a phosphorus compound with the nitrogen-containing polyesterpolyol composition of operation (b) to prepare a phosphorus- and nitrogen-containing polyesterpolyol composition.

8. A method of preparing a phosphorus- and nitrogen-containing polyol, the method comprising:
(a) reacting propylene oxide (P/O) in the presence of an alkali metal catalyst to prepare a polypropylenepolyol composition;
(b) addition-reacting a nitrogen compound with the polypropylenepolyol composition of operation (a) to prepare a nitrogen-containing polyetherpolyol composition; and
(c) addition-reacting a phosphorus compound with the nitrogen-containing polyetherpolyol composition of operation (b) to prepare a phosphorus- and nitrogen-containing polyetherpolyol composition.

9. A method of preparing a phosphorus- and nitrogen-containing polyol, the method comprising:
(a) addition reacting propylene oxide (P/O) and ethylene oxide (E/O) with polyhydric alcohol to prepare a polyhydric alcohol+P/O+E/O-added polyol composition;
(b) addition reacting a nitrogen compound with the polyhydric alcohol+P/O+E/O-added polyol composition of operation (a) to prepare a nitrogen-containing polyetherpolyol composition; and
(c) addition reacting a phosphorus compound with the nitrogen-containing polyetherpolyol composition of operation (b) to prepare a phosphorus- and nitrogen-containing polyetherpolyol composition.

10. The method of claim 9, wherein the polyhydric alcohol comprises at least one selected from the group consisting of ethylene glycol, proplyene glycol, diethylene glycol, 1,4-butane diol, 1,6-hexane diol, neopentyl glycol, dipropylene glycol, trimethylol propane, glycerin, pentaerythritol, a bisphenol A+E/O+P/O adduct, sucrose, and sorbitol.

11. The method of claim 9, wherein the amount of the polyhydric alcohol used is in a range of 1-70 wt % with respect to the polyhydric alcohol+P/O+E/O-added polyol composition.

12. A method of preparing a phosphorus- and nitrogen-containing polyol, the method comprising:
(a) addition reacting propylene oxide (P/O) and ethylene oxide (E/O) with a mixture of polyhydric alcohol and polyamine to prepare a polyhydric alcohol+polyamine+P/O+E/O-added polyol composition;
(b) addition reacting a nitrogen compound with the polyhydric alcohol+polyamine+P/O+E/O-added polyol composition of operation (a) to prepare a nitrogen-containing polyol composition; and
(c) addition reacting a phosphorus compound with the nitrogen-containing polyol composition of operation (b) to prepare a phosphorus- and nitrogen-containing polyol composition.

13. The method of claim 12, wherein the polyhydric alcohol comprises at least one selected from the group consisting of ethylene glycol, proplyene glycol, diethylene glycol, 1,4-butane diol, 1,6-hexane diol, neopentyl glycol, dipropylene glycol, trimethylol propane, glycerin, pentaerythritol, a bisphenol A+E/O+P/O adduct, sucrose, and sorbitol.

14. The method of claim 12, wherein the amount of the polyhydric alcohol used is in a range of 1-70 wt % with respect to the polyhydric alcohol+polyamine+P/O+E/O-added polyol composition.

15. The method of claim 12, wherein the polyamine comprises at least one selected from the group consisting of triethyl amine, propyl amine, butyl amine, ethylene diamine, diethylene triamine, triethylene tetramine, monoethanol amine, diethanol amine, triethanol amine, dimethylethanol amine, 1-amino-2-propanol, morpholine, a morpholine derivative, O-toluenediamine, isophoronediamine, diethyleneglycolamine, dipropyleneglycolamine, hexamethylenediamine, and piperidine.

16. The method of claim 12, wherein the amount of the polyamine used is in a range of 5-120 parts by weight based on 100 parts by weight of the polyhydric alcohol.

17. The method of claim 1, wherein the nitrogen compound comprises at least one selected from the group consisting of melamine, a melamine derivative, urea, a urea derivative, guanidine, a guanidine derivative, dicyandiamide, a dicyandiamide derivative, cyanuric acid, a cyanuric acid derivative, and polyamine.

18. The method of claim 1, wherein the amount of the nitrogen compound used is in a range of 1-70 wt % with respect to the weight of the composition to which the nitrogen compound is added.

19. The method of claim 1, wherein the phosphorus compound comprises at least one selected from the group consisting of ortho-phosphoric acid, pyrophosphoric acid, polyphosphoric acid, phosphorus pentoxide, monophosphoric acid ester, phosphorus oxychloride, phosphorus trichloride, phosphorus pentachloride, alkylphosphite, arylphosphite, dialkylphosphonate, trialkylphosphite, and dialkylhydrogenphosphite.

20. The method of claim 1, wherein the amount of the phosphorus compound used is in a range of 1-50 wt % with respect to the weight of the composition to which the phosphorus compound is added.

21. The method of claim 1, wherein the prepared phosphorus- and nitrogen-containing polyol has an acid value of 0.1-5 mg KOH/g, a hydroxyl value of 20-800 mg KOH/g, and a molecular weight of 200-10,000, and comprises 1-17% of nitrogen and 1-20% of phosphorus.

22. A phosphorus- and nitrogen-containing polyol prepared using the method according to claim 1.

23. The phosphorus- and nitrogen-containing polyol of claim 22, comprising phosphorus- and nitrogen-containing polyester polyol, phosphorus- and nitrogen-containing fatty acid-modified polyester polyol, phosphorus- and nitrogen-containing polyester-amide polyol, phosphorus- and nitrogen-containing polyether-ester-amide polyol, phosphorus- and nitrogen-containing polyetherester polyol, phosphorus- and nitrogen-containing polyether polyol, phosphorus- and nitrogen-containing sorbitol+E/O+P/O-added polyether polyol, phosphorus- and nitrogen-containing sucrose+E/O+P/O-added polyether polyol, phosphorus- and nitrogen-containing polyamine+E/O+P/O-added polyether polyol.

24. A flame-retardant polyurethaneform obtained by reacting isocyanate with a polyol composition prepared by mixing a polyol mixture comprising the phosphorus- and nitrogen-containing polyol according to claim 22, a foaming agent, a reaction catalyst, a surfactant, a flame-retardant, and an additive.

25. The flame-retardant polyurethaneform of claim 24, wherein the amount of the phosphorus- and nitrogen-containing polyol used is in a range of 1-90 wt % with respect to the total weight of the polyol mixture.

26. The flame-retardant polyurethaneform of claim 24, wherein the polyol mixture comprises at least one selected from the group consisting of (a) a polyol mixture comprising 5-70 wt % of phosphorus- and nitrogen-containing polyester polyol, 5-60 wt % of glycerin+E/O+P/O-added polyether polyol, 5-50 wt % of pentaerythritol+E/O+P/O-added polyether polyol, and 5-50 wt % of sucrose+E/O+P/O-added polyether polyol; (b) a polyol mixture comprising 5-70 wt % of phosphorus- and nitrogen-containing polyester-amide polyol, 5-60 wt % of glycerin+E/O+P/O-added polyether polyol, 5-50 wt % of pentaerythritol+E/O+P/O-added polyether polyol, and 5-50 wt % of sucrose+E/O+P/O-added polyether polyol; (c) a polyol mixture comprising 5-70 wt % of phosphorus- and nitrogen-containing polyester polyol, 5-70 wt % of polyester-amide polyol, 5-60 wt % of glycerin+E/O+P/O-added polyether polyol, 5-50 wt % of pentaerythritol+E/O+P/O-added polyether polyol, and 5-50 wt % of sucrose+E/O+P/O-added polyether polyol; (d) a polyol mixture comprising 5-70 wt % of phosphorus- and nitrogen-containing sucrose+E/O+P/O-added polyether polyol, 5-60 wt % of polyester-amide polyol, 5-60 wt % of glycerin+E/O+P/O adduct, 5-50 wt % of pentaerythritol+E/O+P/O-added polyether polyol, and 5-50 wt % of sucrose+E/O+P/O-added polyether polyol; (e) a polyol mixture comprising 5-70 wt % of phosphorus- and nitrogen-containing polyether polyol, 5-70 wt % of polyether-ester-amide polyol, 5-50 wt % of 1,4-butanediol, 5-30 wt % of polyether polyol, and 5-70 wt % of PTMEG; and (f) a polyol mixture comprising 5-70 wt % of phosphorus- and nitrogen-containing polyester-amide polyol, 5-70 wt % of polyether polyol, and 5-50 wt % of polyester polyol.

27. The flame-retardant polyurethaneform of claim 24, wherein the isocyanate is one selected from the group consisting of toluene diisocyanate, hexamethylene diisocyanate, isophorone diisocyanate, xylene diisocyanate, crude-MDI, MDI, polymeric MDI, and isocyanate trimer.

28. The flame-retardant polyurethaneform of claim 24, wherein the isocyanate has NCO % of 28-33.

29. The flame-retardant polyurethaneform of claim 24, wherein a ratio of NCO of isocyanate to hydroxyl group of the polyol (NCO/OH) is in a range of 0.5-1.5.

30. A flame-retardant polyurethane product prepared using the phosphorus- and nitrogen-containing polyol according to claim 22.

31. The flame-retardant polyurethane product of claim 30, wherein the amount of the phosphorus- and nitrogen-containing polyol used is in a range of 1-90 wt % with respect to the total weight of a polyol mixture used in the flame-retardant polyurethane product.

32. The flame-retardant polyurethane product of claim 30, comprising one selected from the group consisting of flame-retardant polyurethane rigid forms, flame-retardant polyurethane flexible forms, flame-retardant polyurethane elastic forms, a flame-retardant polyurethane coating agent, a flame-retardant polyurethane molded product, and flame-retardant artificial wood.
